(19) United States
(12) Patent Application Publication
(10) Pub. No.: US 2002/0110668 A1
(43) Pub. Date: Aug. 15, 2002

(54) Method of forming seamless article covering and articles formed thereby

(75) Inventor: Duane M. Pinault, Cottage Grove, MN (US)

Correspondence Address: Attention: Brian E. Szymanski, Office of Intellectual Property Counsel, 3M Innovative Properties Company, P.O. Box 33427, St. Paul, MN, 55133-3427, US

(73) Assignee: 3M Innovative Properties Company

(21) Appl. No.: 09/784,527

(22) Filed: Feb. 15, 2001

(51) Int. Cl. B32B 5/16

(52) U.S. Cl. 428/150; 428/142; 156/63; 428/143; 428/204; 428/205; 428/207

(57) ABSTRACT

A seamless covering for an article includes a bonding system and a layer of aggregate bonded to the article by the bonding system. The bonding system is preferably a preconstructed article having adhesive on opposing major surfaces. The seamless covering is especially suitable for floor, wall and cementitious object coverings.

### FIELD OF THE INVENTION

The present invention relates to an article covering, particularly to a floor or wall covering including aggregate bonded to the substrate to be covered, and even more particularly to the use of prefabricated bonding systems to bond aggregate to various substrates.

### BACKGROUND

Known seamless floor or wall coverings, as often used in commercial and industrial applications, generally include a polymeric material such as epoxies, urethanes, acrylates, methacrylates applied onto a flooring surface in an unreacted state. An aggregate or pigment component can then be broadcast onto the unreacted polymeric material, and the coating containing the aggregate is then allowed to cure thereby forming a seamless floor. Alternatively, a “trowel mix” consisting of a mixture of aggregate and polymeric material can be prepared and spread over a substrate to create a decorative coating on floors and other objects.

These flooring systems are commonly utilized in buildings for their protective and decorative characteristics. They can be applied over wood, metal, concrete or plastic substrates and are suitable for many different applications. These floors are applied through a variety of methods including spraying, rolling and brushing the wet admixture onto various substrates.

A disadvantage of these known flooring and wallcovering systems is the rigorous preparation of the substrate required prior to the application of the unreacted polymeric material. The process is very time and labor intensive and can greatly add to the cost of replacing the existing floor or wallcovering system. Typically, the flooring to be replaced must be ground down and removed, usually by grinding or sandblasting. This is necessary in order to provide a substrate to which the polymeric material can adhere. Additionally, the grinding and removal can generate large quantities of dust and debris which can cause a potentially hazardous condition. The generation of dust may result in periods of unavailability of areas where the floor is being constructed and may lead to large additional expenses.

An additional disadvantage of conventional systems is the difficulty achieving uniformity of the aggregate on the substrate. This can cause a disproportionate or uneven distribution of expensive aggregate resulting in uneven surfaces, undesired visual patterns, and varying surface textures. These undesirable effects can cause slipping and traction issues on horizontal surfaces.

In view of the above disadvantages, it would be advantageous to develop a flooring system requiring less time for preparation and installation than current flooring systems, and additionally potentially eliminating the necessity for removal of the existing floor.

### SUMMARY OF THE INVENTION

The present invention provides a method for forming an article covering, especially the construction of a flooring system which is less time consuming and more economical than previous methods. A bonding system is applied to a substrate and a layer of aggregate is then applied to the bonding system. This eliminates the necessity of time consuming and expensive preparation of the substrate.

The present invention further provides a novel floor coating system which is more economical than known flooring systems. The flooring system includes a bonding system which is applied to a substrate and an aggregate layer which is applied to the bonding system. The bonding system thus bonds the aggregate to the substrate. Additional body coat and/or topcoat layers can be applied over the aggregate layer.

For purposes of the present invention, the following terms used in this application are defined as follows:

“Polymerize” or “cure” means to alter the physical state and or chemical state of the composition, to make it transform from a fluid to less fluid state, to go from a tacky to a non-tacky state, to go from a soluble to insoluble state, to decrease the amount of polymerizable material by its consumption in a chemical reaction, or to go from a material with a specific molecular weight to a higher molecular weight;

“Bonding System” means a pre-constructed article having adhesive properties on opposing major surfaces;

“Double-Coated Tape” means a pre-constructed article consisting of an interior support web covered on opposing sides by an adhesive layer, the adhesives may be either the same or of different compositions; and

“Transfer Tape” means a pre-constructed article consisting of an adhesive layer releasably attached to a release liner, the adhesive layer can be transferred to a substrate from the release liner thereby establishing opposing adhesive surfaces.

Other features and advantages will be apparent from the following description of the preferred embodiments thereof, and from the claims.

### BRIEF DESCRIPTION OF THE DRAWING

FIG. 1 illustrates an exploded view of an article covering produced in accordance with the invention.

### DETAILED DESCRIPTION OF THE PREFERRED EMBODIMENT

In accordance with the present invention, it has been discovered that a flooring system including a bonding system and an aggregate provides an improved floor over conventional seamless flooring applications in the art.

While the present invention is contemplated as being especially useful in the repair and replacement of existing floors, it is also within the scope of the present invention that it could be used as an original flooring installation in a new construction.

In addition to flooring, the present invention is also considered to be useful for wall coverings, particularly the lower portions of walls. This could be extremely useful in an area such as a food service area, where a seamless wall covering is preferred from a sanitary standpoint. Typically, in such an environment, the wall may be covered to a height of up to about 4-5 feet above the floor. Additionally, the present invention is also considered to be useful for such applications as coating the exterior surfaces of cement articles such as waste cans, picnic tables and countertops, in addition to walls and floors.

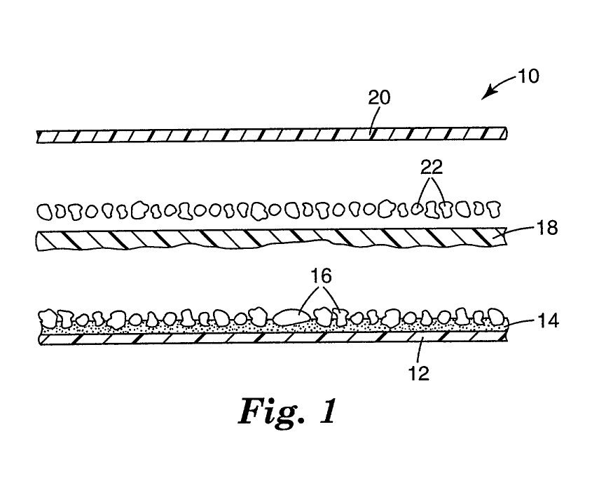

FIG. 1 shows a multi-layer covering 10, according to the present invention. A bonding system 14 is first applied to a substrate 12. Granules 16 are then applied onto the bonding system 14. Optionally, a body coat 18 comprising a polymeric material is applied over the granules 16 and the bonding system 14. An optional embodiment includes the subsequent application of at least another layer of granules 22 cast onto the body coat 18. An optional top coat 20 of a polymeric material may also be applied over the body coat 18 or over subsequent layers of granules 22.

In a preferred embodiment of the present invention, the substrate comprises a floor or subfloor upon which the present invention will be applied. Contrary to known systems, where the substrate must be meticulously prepared by extensive cleaning, likely by the grinding and removal of the old floor, the system of the present invention allows the new floor to be directly overlaid onto the floor to be refinished. The new floor can be laid over the old floor where the old floor is either a seamless floor or a tile floor. In this manner, the present invention decreases the preparation time and expense for the new floor, as only minimal preparation and cleaning must be conducted on the old floor.

In conjunction with the present invention, it is to be understood that the bonding system 14 is a pre-constructed article having adhesive properties on opposing major surfaces. Examples of bonding systems would include, but are not limited to, double-sided tapes and transfer adhesives.

As used herein, double coated tapes refer to adhesive tapes with adhesive on each of the opposing major surfaces. Typically, the tape will comprise a polyethylene film with either the same or different adhesives applied to the opposing major faces. The film will preferably have a thickness of at least 6.25 micrometers, and preferably at least 12.5 micrometers. The tape itself will preferably have a total thickness of 250 micrometers or less.

Transfer adhesives, as used herein, refer to adhesives which are formed on a backing layer, so that when the adhesive is applied to a surface, the backing is removed leaving only the adhesive layer.

Examples of double coated tapes which could be used in embodiments of the present invention are the following products of the Minnesota Mining & Manufacturing Company, St. Paul Minn.: 3M™ #9690Double Coated Tape, comprising a 12.5 micrometer PET film with 50 micrometer high-tack acrylate adhesive on both sides; or 3M™ #443 Double Coated Tape, comprising a 12.5 micrometer PET film with a 50 micrometer synthetic rubber adhesive on both sides. 3M™ #9731 Double Coated Tape, comprising a 12.5 micrometer PET film with 62.5 micrometer high performance acrylic/silicone adhesive on both sides. While these products are suitable for use with the present invention and represent preferred embodiments of the present invention, tapes suitable for use with the present invention are not limited to the above and are intended to incorporate additional double coated adhesive tapes. Typical double coated tapes for use in the present invention may be in rolls of about 61 centimeters width. In some applications, rolls of about 137 centimeters or more may be used. In other applications, narrower rolls may be preferable.

Non-limiting examples of adhesive transfer tapes which could be used in embodiments of the present invention are the following products of the Minnesota Mining & Manufacturing Corporation, St. Paul Minn.,: 3M™ #964 Adhesive Transfer Tape, comprising a kraft paper liner coated with 325 micrometers of acrylate adhesive; or 3M™ #6038 Adhesive Transfer Tape, comprising a kraft paper liner coated with 200 micrometers of acrylate adhesive. While these products are suitable for use with the present invention and represent preferred embodiments of the present invention, transfer adhesive tapes suitable for use with the present invention are not limited to the above and are intended to incorporate additional transfer adhesive tapes.

In a preferred method for forming the floor according to the present invention, as discussed above, the bonding system 14 is first applied to the substrate 12. Typically, the bonding system 14 will be provided in rolls from which strips of the bonding system can be evenly applied to the floor. As discussed above, different sized rolls are available, as needed.

In certain applications, it may be desirable to fully cover the substrate surface utilizing the present inventive method. Therefore, to substantially insure that the substrate is covered, it is preferable to slightly overlap the strips of the bonding system as it is applied. In the case of a double coated tape, this can easily occur by peeling away a small portion of the backing of an applied strip, e.g. about 2.5 to 5 centimeters. The next strip is then positioned on the substrate, overlapping the applied strip where the backing has been removed. The remainder of the backing can be removed in portions, while additional tape is being positioned, or all of the backing can be removed after the entire substrate has been covered. In alternative embodiments of the present invention, the tape can be laid in abutting strips as opposed to overlapping. In such instances, care must be taken to insure that the entire substrate is covered by the bonding system.

In applying the tape to the substrate, it has been found that a roller is useful for evenly applying the tape to the substrate. In particular, it has been found that a roller with a low durometer rubber outer surface can apply a double coated tape to the substrate consistently over the surface of the substrate. This is especially advantageous over low spots in the substrate on which it is difficult to adhere the bonding system to those low spots.

Optionally, a primer system can be applied to the substrate, prior to the application of the bonding system. The primer enhances the bond between the boding system and the substrate. Preferably the primer system can be from the same chemical family as the adhesive of the bonding system. The primer system is also preferably in a fluid form, and can therefore be applied to the substrate by spraying. Alternatively, the primer system can be applied to the substrate by rolling or brushing, in a manner analogous to the way paint would typically be applied. An example of a suitable primer includes 3M™ Scotch Grip 4550 Industrial Adhesive.

Referring again to FIG. 1, following the application of the bonding system 14 to the substrate 12, a layer of aggregate 16 is then applied to the bonding system 14. The bonding system 14 thus serves to bond the aggregate 16 to the substrate 12. The aggregate can preferably be applied by simply scraping or spreading the granules with a trowel or squeegee over the exposed adhesive surface, thus leaving a uniform layer of aggregate. Other conventional methods of applying the aggregate to the bonding system, such as broadcast spreading, are suitable for use with the present invention.

Aggregates suitable for use in the present invention include decorative materials useful in the construction of floor and wall coverings. These materials include, but are not limited to, ceramic coated granules such as ColorQuartz™ from Minnesota Mining and Manufacturing Company, St. Paul. Minn. and colored roofing granules, paint chips, natural stone aggregate, and polymeric particles. A typical quartz aggregate for use in the present invention would include particles of about 750 micrometers. Other materials suitable for use as aggregate in the present invention will be recognizable to those skilled in the art.

After the aggregate is deposited on the bonding system, it is preferable to level the aggregate to provide a substantially uniform layer on the bonding system. This can easily be done manually by, for example, simply sweeping the floor with a broom to remove excess aggregate, thus leaving only the aggregate directly contacting the bonding system.

With reference to FIG. 1, once the aggregate has been sufficiently cast onto the bonding system, an optional body coat layer 18 can be applied. The body coat layer fits around the aggregate particles and forms a coating over the aggregate particles. The body coat polymer material provides a tough, wear-resistant surface which also permanently bonds the aggregate to the substrate to which the aggregate was applied. Conventional polymeric materials suitable for use as a body coat for seamless flooring applications may be used in accordance with the present invention. Examples of suitable body coats would be polymeric materials such as epoxies, urethanes, acrylates, methacrylates and the like. Additional suitable materials include polycarbonates, polyesters, vinyls polyamides and polyolefins. Another example of a body coat suitable for use in the present invention is Glaze 2000, by Seamco Ind. of Tampa, Fla. An additional advantage of the present invention is that the bonding system can be a barrier against the body coat material contacting the subfloor, in a case wherein such contact is not desired.

The body coat layer is spread onto the aggregate/bonding system by means of a device such as a squeegee or paint roller to achieve a thickness upon cure of 250 to 500 micrometers. One skilled in the art will recognize additional suitable body coat materials from the above description.

The application of the body coat is very simple according to the present invention, in that the body coat will tend to self-level upon application. In other words, when the body coat material is applied, it will tend to even itself out over the aggregate already bonded to the bonding system.

According to FIG. 1, subsequent to the application of the body coat material, an optional top coat layer 20 can also be added. The top coat layer can be applied in order to adjust the physical properties of the finished floor, such as the finish, toughness and slip resistance. Typically, the same materials as are used for the body coat are suitable for use as the top coat and applied in the same manner.

In some cases, particularly where the floor is going to be subjected to high shear stresses, for example in a building where construction vehicles are expected, it may be desirable to apply multiple layers of granules and body coats. Such multiple layers are generally referred to as double broadcast, or triple broadcast where three layers of granules and body coat are used. Such additional broadcast layers may be applied using conventional techniques. FIG. 1 depicts an optional double broadcast layer 22 according to the present invention cast between body coat 18 and top coat 20.

It will be appreciated from the above that the shear resistance of the bonding system is an important consideration in the selection of specific adhesives used in the bonding system. The shear resistance in this case meaning the resistance of the adhesive to stress applied essentially parallel to the surface of the bonding system. This is due to the fact, especially in the case of a floor, that the surface is designed to be walked on, and in a commercial or industrial setting, could additionally be driven over by vehicles, thus applying a great deal of shear stress to the finished floor. As the bonding system is either the only or the primary method of bonding the floor to the substrate, it is important that the bonding system provide sufficient shear resistance to maintain the integrity of the floor during the expected use of the floor. Preferably, the shear strength of the present invention is greater than 703 kilograms per square centimeter.

An additional feature of the present invention is that the aggregate can include a variety of materials, or different colors of the same material. Through the use of varying materials or colors, it may be possible to produce decorative patterns in the floor, to add to its aesthetic appeal or to provide visual information such as directional signs.

A floor according to the present invention thus includes a bonding system applied to a substrate, and a granular layer applied to the bonding system and thus bonded to the substrate by the bonding system. The floor can also include a body coat layer and/or a top coat layer. Additional layers of granular material and body coat material can also be applied if necessary.

It has been found that the floor of the present invention can be applied in significantly less time than that normally required for the preparation of a seamless floor, due to simpler application and preparation times, as discussed above. In addition, it has been found that the floor of the present invention can have similar shear resistances and peel strengths as those of known floors.

The following non-limiting examples further illustrate the present invention. The particular materials and amounts recited in these examples, as well as other conditions and details, are to be interpreted broadly in the art and should not be construed to unduly restrict or limit the invention in any way.

Likewise, vertical surfaces can be prepared by applying the bonding system to the vertical surface and blowing or troweling the aggregate material onto the bonding system. A body coat may then be applied to the aggregate surface by means of a paint roller or brush.

### EXAMPLES

### Example 1

A 13 square meter area of floor in an industrial warehouse was cleaned with a mop and soap and water to remove any dust and debris on the surface. The area was squared off using chalk lines as visual guides. 3M™ #9690 Double Coated Tape (Minnesota Mining and Manufacturing Company, St. Paul, Minn.) was applied in long strips each strip overlapping the previous strip by about 5 centimeters. The tape liner was removed and a colored aggregate (3M™ ColorQuartz™, from Minnesota Mining and Manufacturing Company, St. Paul, Minn.) was dispersed onto the upward facing side of the adhesive tape by means of an aluminum trowel. Excess aggregate was vacuumed off using a standard vacuum device. A self-leveling body coat was applied (Seamco 2000 Flooring Resin, Seamco Laboratories, Tampa, Fla.) over the aggregate with a rubber squeegee to a thickness of 250 to 500 micrometers and allowed to cure in situ, thereby providing a decorative seamless floor.

### Example 2

A cement landscaping block having a surface area of 0.3 square meters was given a decorative appearance on one side by applying 3M™ #964 Adhesive Transfer Tape (Minnesota Mining and Manufacturing Company, St. Paul, Minn.) and trimming the excess tape to conform to the shape of the landscaping block. A decorative aggregate (3M™ ColorQuartz™, Minnesota Mining and Manufacturing Company, St. Paul, Minn.) was dispersed over the exposed adhesive surface and the excess was spread around and the excess subsequently removed with a paintbrush. A self-leveling body coat was applied (Seamco 2000 Flooring Resin, Seamco Laboratories, Tampa, Fla.) over the aggregate with a paintbrush to provide a 250 to 500 micrometer thickness and allowed to cure in situ, thereby providing a tough, attractive decorative surface.

From the above disclosure and the general principles of the present invention and the preceding detailed description, those skilled in this art will readily comprehend the various modifications to which the present invention is susceptible. Therefore, the scope of the invention should be limited only by the following claims and equivalents thereof.

What is claimed is:

1. A method of applying a multi-layer structure for forming a covering, comprising:
bonding a plurality of granules to a substrate using a bonding system.

2. The method of claim 1 further comprising applying a body coat over the plurality of granules.

3. The method of claim 2 wherein the body coat comprises a material selected from epoxies, acrylates, urethanes, isocyanates, polyesters, polycarbonates, vinyls or mixtures thereof.

4. The method according to claim 1 wherein the bonding system comprises one of a double coated tape and a transfer adhesive.

5. The method according to claim 2, further comprising applying a top coat to the body coat.

6. The method according to claim 5 wherein the top coat comprises a material selected from epoxies, acrylates, urethanes, isocyanates, polyesters, polycarbonates, vinyls or mixtures thereof.

7. The method according to claim 1, further comprising forming a substantially uniform layer of granules on the bonding system.

8. The method according to claim 1, wherein said plurality of granules comprise a material selected from ceramic coated granules, colored roofing granules, paint chips, natural stone aggregate, quartz, sand, polymeric particles or mixtures thereof.

9. The method according to claim 1, further comprising applying the plurality of granules to form a pattern.

10. The method according to claim 9 wherein the plurality of granules comprise different colored granules.

11. The method according to claim 2, further comprising:
applying at least one additional granular layer to a body coat; and
applying an additional body coat to each of the at least one additional granular layers.

12. The method according to claim 1 comprising applying a primer system to the substrate to improve the adhesion of the bonding system to the substrate.

13. A multi-layer structure for forming a covering, comprising:
a bonding system adhered to a substrate and defining an adhesive surface opposite the substrate; and
a granular layer comprised of a plurality of granules disposed on the adhesive surface of the bonding system, wherein the bonding system secures the granular layer to the substrate.

14. The multi-layer structure of claim 13 further comprising a body coat disposed over the granular layer and forming an outer surface opposite the substrate.

15. The multi-layer structure of claim 14 wherein the body coat comprises a material selected from epoxies, acrylates, urethanes, isocyanates, polyesters, polycarbonates, vinyls or mixtures thereof.

16. The multi-layer structure of claim 13, wherein the bonding system comprises a double coated tape.

17. The multi-layer structure of claim 13, wherein the bonding system comprises a transfer adhesive.

18. The multi-layer structure of claim 13, wherein the plurality of granules comprise granules of different colors.

19. The multi-layer structure of claim 14 further comprising:
an additional granular layer comprised of a plurality of granules disposed on the outer surface; and
an additional body coat disposed over the additional granular layer.

20. The multi-layer structure of claim 15 comprising a top coat disposed over said body coat.

21. The multi-layer structure of claim 20 wherein the top coat comprises a material selected from epoxies, acrylates, urethanes, isocyanates, polyesters, polycarbonates, vinyls or mixtures thereof.

22. The multi-layer structure of claim 13 further comprising a primer system applied to the substrate to provide better adhesion of the bonding system to the substrate.

23. A multi-layer structure for forming a covering, comprising:
a double coated tape adhered to a substrate and defining an adhesive surface opposite the substrate;
a granular layer comprised of a plurality of granules disposed on the adhesive surface of the bonding system; and
a body coat applied over the the granular layer and forming an outer surface opposite the substrate;
wherein the double coated tape secures the granular layer to the substrate.
